(19) United States
(12) Patent Application Publication
(10) Pub. No.: US 2014/0300950 A1
(43) Pub. Date: Oct. 9, 2014

(54) LASER APPARATUS

(71) Applicant: GIGAPHOTON INC., Oyama-shi (JP)

(72) Inventors: Krzysztof NOWAK, Oyoma-shi (JP); Osamu WAKABAYASHI, Hiratsuka-shi (JP)

(21) Appl. No.: 14/310,845

(22) Filed: Jun. 20, 2014

Related U.S. Application Data
(63) Continuation of application No. PCT/IB2012/001829, filed on Sep. 19, 2012.

(30) Foreign Application Priority Data
Dec. 22, 2011 (JP) 2011-282134

(51) Int. Cl. H01S 3/00

(52) U.S. Cl. CPC H01S 3/0078
USPC 359/333

(57) ABSTRACT

A laser apparatus includes at least one oscillator configured to output a first laser beam; a filter device provided in a beam path of the first laser beam, the filter device including either an optical element having transmittance properties depending on a polarization direction and a wavelength and a filter device including a wavelength dispersive element; and at least one amplifier configured to amplify a second laser beam from the filter device and output as a third laser beam.

### CROSS-REFERENCE TO RELATED APPLICATION

This application is a continuation of PCT International Application No. PCT/IB2012/001829 filed on Sep. 19, 2012 which claims the benefit of priority from Japanese Patent Applications No. 2011-282134, filed on Dec. 22, 2011; the entire contents of which are incorporated herein by reference.

### BACKGROUND

1. Technical Field

The present disclosure relates to a laser apparatus.

2. Related Art

In recent years, semiconductor production processes have become capable of producing semiconductor devices with increasingly fine feature sizes, as photolithography has been making rapid progress toward finer fabrication. In the next generation of semiconductor production processes, microfabrication with feature sizes at 60 nm to 45 nm, and further, microfabrication with feature sizes of 32 nm or less will be required. In order to meet the demand for microfabrication with feature sizes of 32 nm or less, for example, an exposure apparatus is needed in which a system for generating EUV light at a wavelength of approximately 13 nm is combined with a reduced projection reflective optical system.

Three kinds of systems for generating EUV light are known in general, which include a Laser Produced Plasma (LPP) type system in which plasma is generated by irradiating a target material with a laser beam, a Discharge Produced Plasma (DPP) type system in which plasma is generated by electric discharge, and a Synchrotron Radiation (SR) type system in which orbital radiation is used to generate plasma.

### SUMMARY

A laser apparatus according to an aspect of the present disclosure may include: at least one oscillator configured to output a first laser beam; a filter device provided in a beam path of the first laser beam, the filter device including either an optical element having transmittance properties depending on a polarization direction and a wavelength or a wavelength dispersive element; and at least one amplifier configured to amplify a second laser beam from the filter device and output as a third laser beam.

### BRIEF DESCRIPTION OF THE DRAWINGS

Hereinafter, selected embodiments of the present disclosure will be described with reference to the accompanying drawings.

FIG. 1 schematically illustrates an exemplary configuration of a laser apparatus according to a first embodiment of the present disclosure.

FIG. 2 shows an exemplary configuration of a dichroic mirror used in a wavelength filter device shown in FIG. 1.

FIG. 3 shows wavelength dependence of transmittance on polarization in the dichroic mirror shown in FIG. 2.

FIG. 4 schematically illustrates an exemplary configuration of a wavelength filter device according to a first example of the first embodiment.

FIG. 5 shows an exemplary configuration of a polarization mirror used in a wavelength filter device shown in FIG. 1.

FIG. 6 shows wavelength dependence of reflectance on polarization in the polarization mirror shown in FIG. 5.

FIG. 7 schematically illustrates an exemplary configuration of a wavelength filter device according to a second example of the first embodiment.

FIG. 8 schematically illustrates an exemplary configuration of a wavelength filter device according to a third example of the first embodiment.

FIG. 9 shows a transmittance spectrum of the etalon shown in FIG. 8.

FIG. 10 schematically illustrates an exemplary configuration of a wavelength filter device according to a fourth example of the first embodiment.

FIG. 11 shows wavelength selectivity of the wavelength filter device shown in FIG. 10.

FIG. 12 schematically illustrates an exemplary configuration of a wavelength filter device which further includes a single polarization filter.

FIG. 13 shows wavelength dependence of reflectance on polarization in the optical elements shown in FIG. 12.

FIG. 14 schematically illustrates an exemplary configuration of a wavelength filter device which further includes two polarization filters.

FIG. 15 schematically illustrates a configuration of an exemplary LPP type EUV light generation system.

FIG. 16 schematically illustrates an exemplary configuration of an EUV light generation system according to a second embodiment of the present disclosure.

FIG. 17 schematically illustrates an exemplary configuration of a fast-axial-flow amplifier.

FIG. 18 schematically illustrates an exemplary configuration of a slab amplifier.

FIG. 19 schematically illustrates an exemplary configuration of a triaxial orthogonal amplifier.

FIG. 20 is a sectional view of the triaxial orthogonal amplifier shown in FIG. 19, taken along XX-XX plane.

FIG. 21 schematically illustrates an exemplary configuration of a CO₂ laser, which may be used as a master oscillator.

FIG. 22 schematically illustrates an exemplary configuration of a quantum cascade laser, which may be used as a master oscillator.

### DETAILED DESCRIPTION

Hereinafter, selected embodiments of the present disclosure will be described in detail with reference to the accompanying drawings. The embodiments to be described below are merely illustrative in nature and do not limit the scope of the present disclosure. Further, the configuration(s) and operation(s) described in each embodiment are not all essential in implementing the present disclosure. Note that like elements are referenced by like reference numerals and characters, and duplicate descriptions thereof will be omitted herein. The embodiments of the present disclosure will be described following the table of contents below.

### Contents

### 1. Overview

### 2. Terms

### 3. Laser Apparatus Including Wavelength Filter Device: First Embodiment

### 3.1 Configuration

### 3.2 Operation

### 3.3 Effect

### 3.4 Wavelength Filter Device

### 3.4.1 Wavelength Filter Device Including Transmissive Optical Element Having Dependence on Both Polarization and Wavelength

### 3.4.1.1 Transmissive Optical Element

### 3.4.1.2 Wavelength Dependence of Transmittance on Polarization in Dichroic Mirror

### 3.4.1.3 Configuration of Wavelength Filter Device

### 3.4.1.4 Operation of Wavelength Filter Device

### 3.4.1.5 Effect

### 3.4.2 Wavelength Filter Device Including Reflective Optical Element Having Dependence on Both Polarization and Wavelength

### 3.4.2.1 Reflective Optical Element

### 3.4.2.2 Wavelength Dependence of Reflectance on Polarization in Polarization Mirror

### 3.4.2.3 Configuration of Wavelength Filter Device

### 3.4.2.4 Operation of Wavelength Filter Device

### 3.4.2.5 Effect

### 3.4.3 Wavelength Filter Device Including Wavelength Dispersive Element

### 3.4.3.1 Configuration of Wavelength Filter Device

### 3.4.3.2 Wavelength Dependence of Transmittance in Wavelength Dispersive Element

### 3.4.3.3 Effect

### 3.4.4 Wavelength Filter Device Including Grating and Slit

### 3.4.4.1 Configuration of Wavelength Filter Device

### 3.4.4.2 Wavelength Selectivity of Wavelength Filter Device Including Grating and Slit

### 3.4.4.3 Effect

### 3.5 Wavelength Filter Device Including Polarization Filter

### 3.5.1 Wavelength Filter Device Including Single Polarization Filter

### 3.5.1.1 Configuration

### 3.5.1.2 Wavelength Dependence of Reflectance on Polarization in Optical Elements

### 3.5.1.3 Operation

### 3.5.1.4 Effect

### 3.5.2 Wavelength Filter Device Including Multiple Polarization Filters

4. EUV Light Generation Apparatus Used with Laser Apparatus

### 4.1 Exemplary Laser Produced Plasma Type EUV Light Generation System

### 4.1.1 Configuration

### 4.1.2 Operation

4.2 EUV Light Generation Apparatus Used with Laser Apparatus Including Wavelength Filter Device: Second Embodiment

### 4.2.1 Configuration

### 4.2.2 Effect

### 5. Examples of Amplifier

### 5.1 Fast-Axial-Flow Amplifier

### 5.2 Slab Amplifier

### 5.3 Triaxial Orthogonal Amplifier

### 6. Examples of Master Oscillator

### 6.1 CO₂ Laser

### 6.2 Distributed Feedback Laser

### 1. Overview

In the embodiments to be described below, a laser apparatus will be illustrated which includes a master oscillator configured to output a pulse laser beam and at least one amplifier configured to amplify the pulse laser beam. Such a laser apparatus may, for example, be used with an LLP type EUV light generation apparatus.

The stated laser apparatus may be a CO₂ laser apparatus which contains CO₂ gas as a primary gain medium. A CO₂ laser apparatus for an LPP type EUV light generation apparatus may be required to output a high-energy pulse laser beam at a high repetition rate.

However, in such a CO₂ laser apparatus, aside from pulses outputted from a master oscillator, amplified spontaneous emission (ASE) in an amplifier may lead to self-oscillation. Wavelengths at which the stated CO₂ laser apparatus undergoes self-oscillation include, aside from a wavelength of 10.6 μm, a wavelength of 9.6 μm, and self-oscillation at a wavelength of 9.6 μm may be suppressed.

Accordingly, in the embodiments to be described below, the laser apparatus may further include at least one wavelength filter device provided in a beam path of a pulse laser beam and configured to attenuate light at unwanted wavelengths.

### 2. Terms

In the present disclosure, a Z-direction is defined as a direction in which a laser beam travels. An X-direction is perpendicular to the Z-direction, and a Y-direction is perpendicular to both the Z-direction and the X-direction. The X-direction and the Y-direction may be rotated as the direction in which the laser beam travels changes. For example, when the Z-direction changes within an X-Z plane, the X-direction is rotated in accordance with the change in the Z-direction, but the Y-direction remains unchanged. Similarly, when the Z-direction changes within a Y-Z plane, the Y-direction is rotated in accordance with the change in the Z-direction, but the X-direction remains unchanged.

### 3. Laser Apparatus Including Wavelength Filter Device: First Embodiment

3.1 Configuration

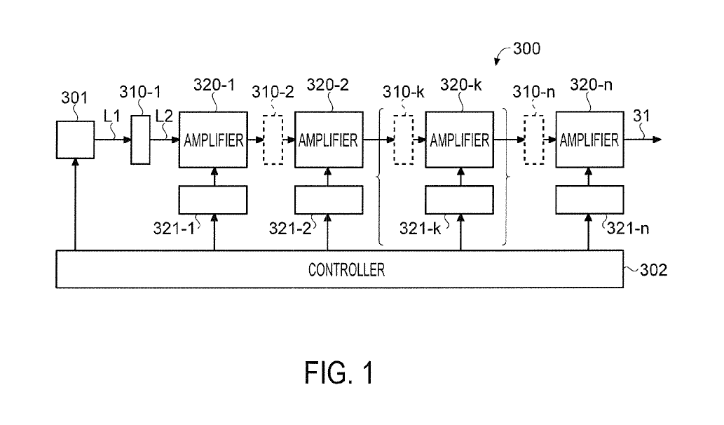

FIG. 1 schematically illustrates an exemplary configuration of a laser apparatus according to a first embodiment of the present disclosure. As shown in FIG. 1, a laser apparatus 300 may include a master oscillator 301, wavelength filter devices 310-1 through 310-n, amplifiers 320-1 through 320-n, power supplies 321-1 through 321-n, and a controller 302. Here, the laser apparatus 300 may include only one wavelength filter device. In the description to follow, when a distinction is not made among the wavelength filter devices 310-1 through 310-n, a wavelength filter device may be referenced by reference numeral 310. Similarly, when a distinction is not made among the amplifiers 320-1 through 320-n or a distinction is not made among the power supplies 321-1 through 321-n, an amplifier may be referenced by reference numeral 320 and a power supply may be referenced by reference numeral 321.

The amplifiers 320-1 through 320-n may be provided in series in a beam path of a pulse laser beam L2 from the master oscillator 301. The wavelength filter device 310-1 may be provided in a beam path between the master oscillator 301 and the amplifier 320-1. The wavelength filter devices 310-2 through 310-n may respectively be provided in a beam path between any two adjacent amplifiers 320-1 through 320-n.

The amplifier 320 may, for example, contain CO₂ gas as a primary gain medium. Hereinafter, a gain medium contained in the amplifier 320 may be referred to as a CO₂ laser gas. The amplifier 320 may be supplied with electric power from the power supply 321. The amplifier 320 may be configured to cause an electric discharge to occur in the CO₂ laser gas thereinside using the supplied electric power. While the electric discharge occurs, a pulse laser beam L2 traveling in the amplifier 320 may be amplified.

The wavelength filter device 310 may be configured to transmit a ray at a wavelength of the pulse laser beam L1 outputted from the master oscillator 301 with high transmittance and suppress transmission of rays at wavelengths other than the wavelength of the pulse laser beam L1. In the first embodiment, the master oscillator 301 may oscillate in a single longitudinal mode, and the wavelength of the pulse laser beam L1 may, for example, be 10.6 μm. Rays of light to be blocked by the wavelength filter device 310 may, for example, include ASE light at a wavelength of 9.6 μm.

The controller 302 may be configured to supply a trigger signal to the master oscillator 301 to cause the master oscillator 301 to oscillate. The trigger signal may be inputted to the master oscillator 301 at a predetermined repetition rate. Further, the controller 302 may drive the power supply 321, to thereby supply electric power to the amplifier 320. Thus, an electric discharge may occur in the CO₂ laser gas inside the amplifier 320, and an amplification region may be formed inside the amplifier 320.

3.2 Operation

In the laser apparatus 300 shown in FIG. 1, trigger signals may be inputted to the master oscillator 301 from the controller 302 at a predetermined repetition rate. Then, the pulse laser beam L1 may be outputted from the master oscillator 301 at the predetermined repetition rate. The amplifiers 320-1 through 320-n may be supplied with electric power from the respective power supplies 321-1 through 321-n. Then, an amplification region may be formed in each of the amplifiers 320-1 through 320-n. Duration in which the electric power is supplied to the amplifiers 320-1 through 320-n from the respective power supplies 321-1 through 321-n is not limited to the duration in which the master oscillator 301 outputs the pulse laser beam L1. For example, the electric power may be supplied to the amplifiers 320-1 through 320-n even while the pulse laser beam L1 is not outputted. Accordingly, the amplification of the pulse laser beam L2 by the amplifiers 320-1 through 320-n may be stabilized.

The pulse laser beam L1 outputted from the master oscillator 301 may first enter the wavelength filter device 310-1. The wavelength filter device 310-1 may, for example, be configured to transmit the pulse laser beam L1 at a wavelength of 10.6 μm as the pulse laser beam L2 and prevent rays at other wavelengths from being transmitted therethrough. The wavelength filter device 310-1 may also serve to prevent a backpropagating laser beam from traveling toward the master oscillator 301. The backpropagating light may, for example, include ASE light at a wavelength of 9.6 μm from the amplifier 320.

The pulse laser beam L2 transmitted through the wavelength filter device 310-1 may enter the amplifier 320-1. The amplifier 320-1 may then amplify the pulse laser beam L2. Thereafter, the pulse laser beam L2 outputted from the amplifier 320-1 may pass through the amplifiers 320-2 through 320-n, to thereby be further amplified, and be outputted from the laser apparatus 300 as a pulse laser beam 31. The wavelength filter devices 310-2 through 310-n may be provided in a beam path upstream from the respective amplifiers 320-2 through 320-n. Thus, the pulse laser beam L2 outputted from the amplifier 320-1 may pass through the respective wavelength filter devices 310-2 through 310-n prior to entering the respective amplifiers 320-2 through 320-n.

3.3 Effect

As described above, the wavelength filter devices 310-1 through 310-n may be provided in a beam path upstream from the respective amplifiers 320-1 through 320-n. Accordingly, ASE light generated in the amplifiers 320-1 through 320-n may be prevented from entering components provided upstream or downstream from the respective amplifiers 320-1 through 320-n. Such components may include the master oscillator 301 and the amplifier 320. Accordingly, the ASE light may be prevented from being outputted from the laser apparatus 300.

Here, the wavelength filter device 310 may be configured to block light in a wavelength range of from 9.3 μm to 9.6 μm inclusive. When each wavelength filter device 310 is provided upstream from each amplifier 320, the ASE light generated in an amplifier 320 may be further reduced, and self-oscillation may be suppressed more reliably.

3.4 Wavelength Filter Device

The wavelength filter device 310 shown in FIG. 1 will now be described in detail with specific examples. In the description to follow, an amplifier provided upstream from a wavelength filter device may be referenced by a reference symbol 320a and an amplifier provided downstream from the wavelength filter device may be referenced by a reference symbol 320b. Each of the amplifiers 320a and 320b may be similar to the above-described amplifier 320. Further, a pulse laser beam outputted from the upstream amplifier 320a may be referred to as a pulse laser beam La and a pulse laser beam transmitted through the wavelength filter device may be referred to as a pulse laser beam Lc.

3.4.1 Wavelength Filter Device Including Transmissive Optical Element Having Dependence on Both Polarization and Wavelength

A wavelength filter device including a transmissive optical element having dependence on both polarization and wavelengths will be illustrated first. An optical element such as a dichroic mirror configured to transmit light at a particular wavelength with high transmittance and reflect light at another particular wavelength with high reflectance may be used. However, the present disclosure is not limited thereto.

3.4.1.1 Transmissive Optical Element

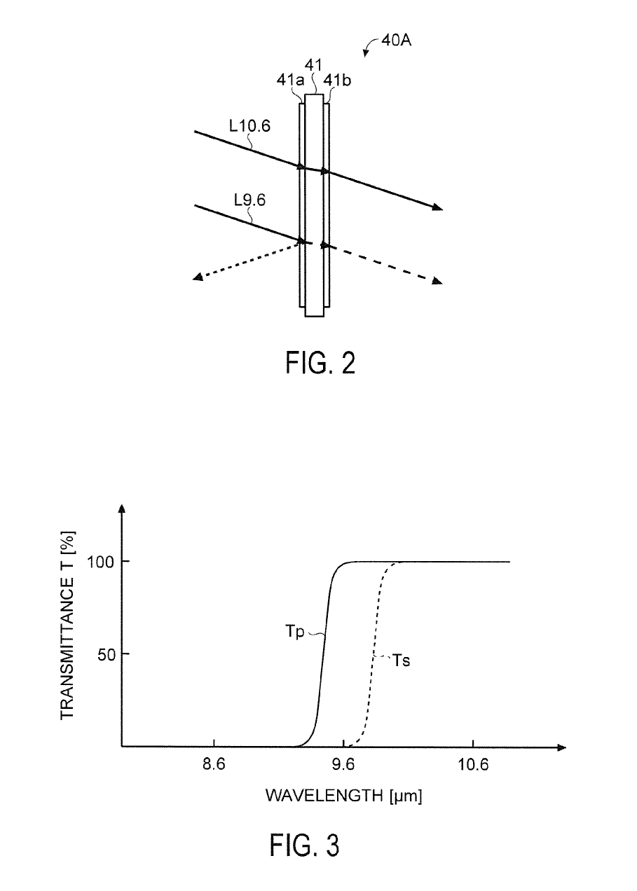

FIG. 2 shows an exemplary configuration of a dichroic mirror used in a wavelength filter device. As shown in FIG. 2, a dichroic mirror 40A may, for example, include a transparent substrate 41 configured to transmit both light L10.6 at a wavelength of 10.6 μm and light L9.6 at a wavelength of 9.6 μm with high transmittance. The transparent substrate 41 may be coated on a first surface thereof with a film 41a configured to substantially reflect the P-polarization component of light at wavelengths shorter than approximately 9.3 μm and transmit the P-polarization component of light at wavelengths longer than approximately 9.3 μm. The film 41a may also be configured to substantially reflect the S-polarization component of light at wavelengths shorter than approximately 9.6 μm and substantially transmit the S-polarization component of light at wavelengths longer than approximately 9.6 μm. The transparent substrate 41 may be coated on a second surface thereof with a film 41b configured to transmit light with high transmittance. With this configuration, the dichroic mirror 40A may be positioned such that the pulse laser beam L1 or L2 is incident on the first surface thereof.

3.4.1.2 Wavelength Dependence of Transmittance on Polarization in Dichroic Mirror

FIG. 3 shows wavelength dependence of transmittance on polarization in the dichroic mirror shown in FIG. 2. In FIG. 3, a solid line Tp shows transmittance of the P-polarization component, and a broken line Ts shows transmittance of the S-polarization component. In the example shown in FIGS. 2 and 3, the dichroic mirror 40A may be configured to substantially reflect the P-polarization component of light at wavelengths shorter than approximately 9.3 μm and transmit light at wavelengths longer than approximately 9.3 μm. Further, the dichroic mirror 40A may be configured to substantially reflect the S-polarization component of light at wavelengths shorter than approximately 9.6 μm and transmit light at wavelengths longer than approximately 9.6 μm. In this way, the transmittance through the dichroic mirror 40A may have distinct wavelength dependence on the P-polarization component and on the S-polarization component.

3.4.1.3 Configuration of Wavelength Filter Device

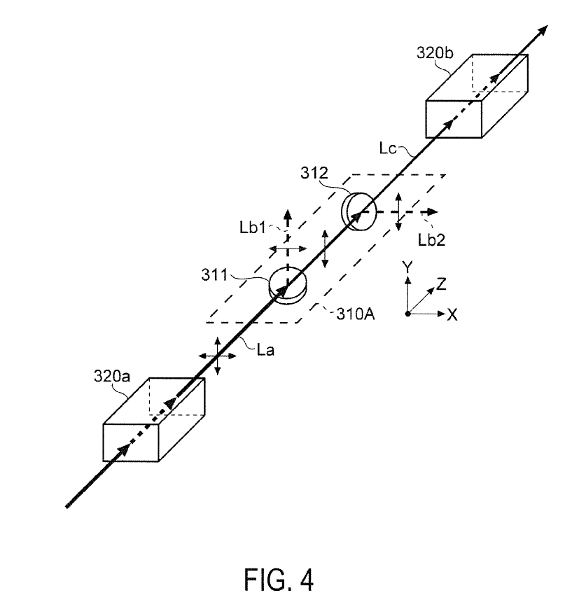

FIG. 4 schematically illustrates an exemplary configuration of a wavelength filter device according to a first example of the first embodiment. As shown in FIG. 4, a wavelength filter device 310A may include at least two dichroic mirrors 311 and 312. Each of the dichroic mirrors 311 and 312 may be configured similarly to the dichroic mirror 40A shown in FIG. 2.

The pulse laser beam La outputted from the amplifier 320a may include a pulse laser beam at a wavelength of 10.6 μm and ASE light at a wavelength of 9.6 μm. Here, in the case where electric power is supplied to the amplifier 320a from a power supply (not separately shown) even while the pulse laser beam L1 is not outputted from the master oscillator 301 (see FIG. 1), the ASE light may be outputted from the amplifier 320a. The ASE light may be unpolarized.

Each of the dichroic mirrors 311 and 312 may be positioned such that the pulse laser beam La is incident thereon at an angle, for example, of 45 degrees. By adjusting the direction and the angle of inclination of the dichroic mirrors 311 and 312 relative to the beam path, unwanted light, such as the ASE light, may be suppressed effectively. In the example shown in FIG. 4, the dichroic mirror 311 may be inclined such that the plane of incidence lies on the Y-Z plane. Meanwhile, the dichroic mirror 312 may be inclined such that the plane of incidence lies on the X-Z plane. Here, each of the dichroic mirrors 311 and 312 may be positioned such that the direction of inclination of the dichroic mirror 311 and the direction of inclination of the dichroic mirror 312 are at an angle of 90 degrees with the beam path of the pulse laser beam La serving as the axis of rotation.

3.4.1.4 Operation of Wavelength Filter Device

In the wavelength filter device 310A shown in FIG. 4, with regard to the pulse laser beam La incident on the dichroic mirror 311, the P-polarization component at wavelengths equal to or shorter than 9.3 μm and the S-polarization component at wavelengths equal to or shorter than 9.6 μm may be reflected by the dichroic mirror 311 with high reflectance. Accordingly, of the unpolarized ASE light at a wavelength of 9.6 μm contained in the pulse laser beam La, the S-polarization component may be reflected as a pulse laser beam Lb1. Meanwhile, of the pulse laser beam La incident on the dichroic mirror 311, the P-polarization component at wavelengths longer than 9.3 μm and the S-polarization component at wavelengths longer than 9.6 μm may be transmitted through the dichroic mirror 311 and be incident on the dichroic mirror 312.

Similarly, of the pulse laser beam La incident on the dichroic mirror 312, the P-polarization component at wavelengths equal to or shorter than 9.3 μm and the S-polarization component at wavelengths equal to or shorter than 9.6 μm may be reflected by the dichroic mirror 312 with high reflectance. Accordingly, the S-polarization component of the ASE light at a wavelength of 9.6 μm contained in the pulse laser beam La transmitted through the dichroic mirror 311 may be reflected by the dichroic mirror 312 as a pulse laser beam Lb2. Meanwhile, with regard to the pulse laser beam La incident on the dichroic mirror 312, the P-polarization component at wavelengths longer than 9.3 μm and the S-polarization component at wavelengths longer than 9.6 μm may be transmitted through the dichroic mirror 312 and be outputted from the wavelength filter device 310A as a pulse laser beam Lc. Accordingly, the pulse laser beam Lc entering the amplifier 320b may primarily be a linearly polarized pulse laser beam polarized in the X-direction at wavelengths longer than 9.6 μm.

3.4.1.5 Effect

As described above, the wavelength filter device 310A may be configured to suppress passage of unwanted ASE light, for example, at a wavelength of 9.6 μm effectively using wavelength dependence of transmittance on polarization in the respective dichroic mirrors 311 and 312. As a result, self-oscillation in the laser apparatus 300 by the unwanted ASE light may be suppressed.

3.4.2 Wavelength Filter Device Including Reflective Optical Element Having Dependence on Both Polarization and Wavelength

A wavelength filter device including a reflective optical element having dependence on both polarization and wavelengths will now be illustrated. A polarizer, such as a polarization mirror, configured to reflect light at a specific wavelength may be used. However, the present disclosure is not limited thereto.

3.4.2.1 Reflective Optical Element

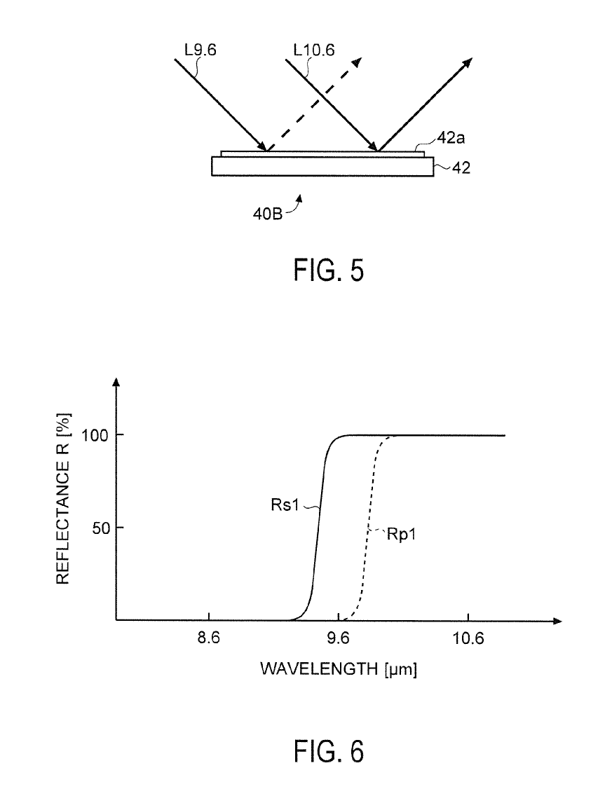

FIG. 5 shows an exemplary configuration of a polarization mirror used in a wavelength filter device. As shown in FIG. 5, a polarization mirror 40B may include a substrate 42. The substrate 42 may be coated on one surface thereof with a film 42a configured to substantially absorb or transmit the S-polarization component of light at wavelengths shorter than approximately 9.3 μm and substantially reflect the S-polarization component of light at wavelengths longer than approximately 9.3 μm. The film 42a may also be configured to substantially absorb or transmit the P-polarization component of light at wavelengths shorter than approximately 9.6 μm and substantially reflect the P-polarization component of light at wavelengths longer than approximately 9.6 μm.

3.4.2.2 Wavelength Dependence of Reflectance on Polarization in Polarization Mirror

FIG. 6 shows wavelength dependence of reflectance on polarization in the polarization mirror shown in FIG. 5. In FIG. 6, a solid line Rs1 shows reflectance of the S-polarization component, and a broken line Rp1 shows reflectance of the P-polarization component. In the example shown in FIGS. 5 and 6, the polarization mirror 40B may be configured to substantially absorb or transmit the S-polarization component of light at wavelengths equal to or shorter than 9.3 μm and substantially reflect the S-polarization component of light at wavelengths longer than 9.3 μm. Meanwhile, the polarization mirror 40B may be configured to substantially absorb or transmit the P-polarization component of light at wavelengths equal to or shorter than 9.6 μm and substantially reflect the P-polarization component of light at wavelengths longer than 9.6 μm. Thus, reflectance of the polarization mirror 40B may have distinct wavelength dependence on the P-polarization component and on the S-polarization component.

3.4.2.3 Configuration of Wavelength Filter Device

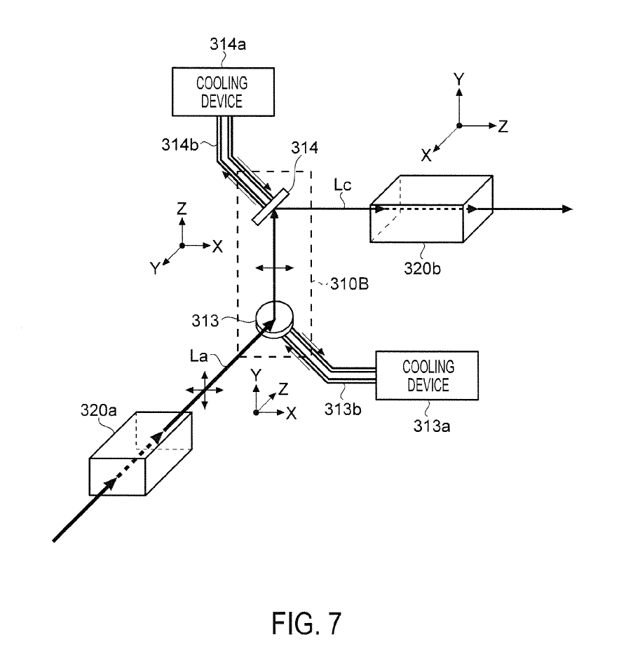

FIG. 7 schematically illustrates an exemplary configuration of a wavelength filter device according to a second example of the first embodiment. As shown in FIG. 7, a wavelength filter device 310B may include polarization mirrors 313 and 314. Each of the polarization mirrors 313 and 314 may be configured similarly to the polarization mirror 40B shown in FIG. 5. Further, the wavelength filter device 310B may have a cooling mechanism configured to cool each of the polarization mirrors 313 and 314. The cooling mechanism may include cooling devices 313a and 314a and pipes 313b and 314b.

Each of the polarization mirrors 313 and 314 may be positioned such that the pulse laser beam La is incident thereon at an angle, for example, of 45 degrees. Here, by adjusting the direction and the angle of inclination of the polarization mirrors 313 and 314 relative to the beam path, unwanted light, such as ASE light, may be suppressed effectively. In the example shown in FIG. 7, the polarization mirror 313 may be positioned such that the plane of incidence thereof lies on the Y-Z plane. Meanwhile, the polarization mirror 314 may be positioned such that the plane of incidence thereof lies on the X-Z plane. Further, a line normal to the reflective surface of the polarization mirror 313 may be substantially orthogonal to a line normal to the reflective surface of the polarization mirror 314.

3.4.2.4 Operation of Wavelength Filter Device

In the wavelength filter device 310B shown in FIG. 7, with regard to the pulse laser beam La incident on the polarization mirror 313, the S-polarization component at wavelengths equal to or shorter than 9.3 μm and the P-polarization component at wavelengths equal to or shorter than 9.6 μm may be absorbed by the polarization mirror 313 or transmitted through the polarization mirror 313. The P-polarization component of the light at wavelengths equal to or shorter than 9.6 μm may include the P-polarization component of the unpolarized ASE light at a wavelength of 9.6 μm. Meanwhile, with regard to the pulse laser beam La incident on the polarization mirror 313, the S-polarization component at wavelengths longer than 9.3 μm and the P-polarization component at wavelengths longer than 9.6 μm may be reflected by the polarization mirror 313 and be incident on the polarization mirror 314.

Similarly, with regard to the pulse laser beam La incident on the polarization mirror 314, the S-polarization component at wavelengths equal to or shorter than 9.3 μm and the P-polarization component at wavelengths equal to or shorter than 9.6 μm may be absorbed by the polarization mirror 314 or transmitted through the polarization mirror 314. Meanwhile, with regard to the pulse laser beam La incident on the polarization mirror 314, the S-polarization component at wavelengths longer than 9.3 μm and the P-polarization component at wavelengths longer than 9.6 μm may be reflected by the polarization mirror 314 and be outputted from the wavelength filter device 310B as the pulse laser beam Lc. Thus, the pulse laser beam Lc entering the amplifier 320b may be a linearly polarized pulse laser beam polarized in the Y-direction at wavelengths longer than 9.6 μm.

The polarization mirrors 313 and 314 may have a cooling medium supplied from the respective cooling devices 313a and 314a through the respective pipes 313b and 314b. The cooling medium may flow through a flow channel (not separately shown) formed inside each of the polarization mirrors 313 and 314, to thereby cool the polarization mirrors 313 and 314. Then, the cooling medium may return to the cooling devices 313a and 314a through the respective pipes 313b and 314b and be cooled therein. Thereafter, the cooling medium may again flow into the polarization mirrors 313 and 314 through the respective pipes 313b and 314b. The cooling medium may be a liquid, such as cooling water or oil.

3.4.2.5 Effect

As described above, the wavelength filter device 310B may be configured to effectively suppress passage of unwanted ASE light at a wavelength of 9.6 μm using dependence of reflectance on both polarization and wavelengths in the respective polarization mirrors 313 and 314. As a result, self-oscillation in the laser apparatus 300 by the ASE light may be suppressed. Further, a rise in a temperature of the polarization mirrors 313 and 314 caused by absorbing light energy may be suppressed using the cooling mechanism. Thus, the filtering properties of the wavelength filter device 310B may be stabilized.

3.4.3 Wavelength Filter Device Including Wavelength Dispersive Element

A wavelength filter device including a wavelength dispersive element will now be illustrated. A wavelength dispersive element such as an etalon may be used. However, the present disclosure is not limited thereto.

3.4.3.1 Configuration of Wavelength Filter Device

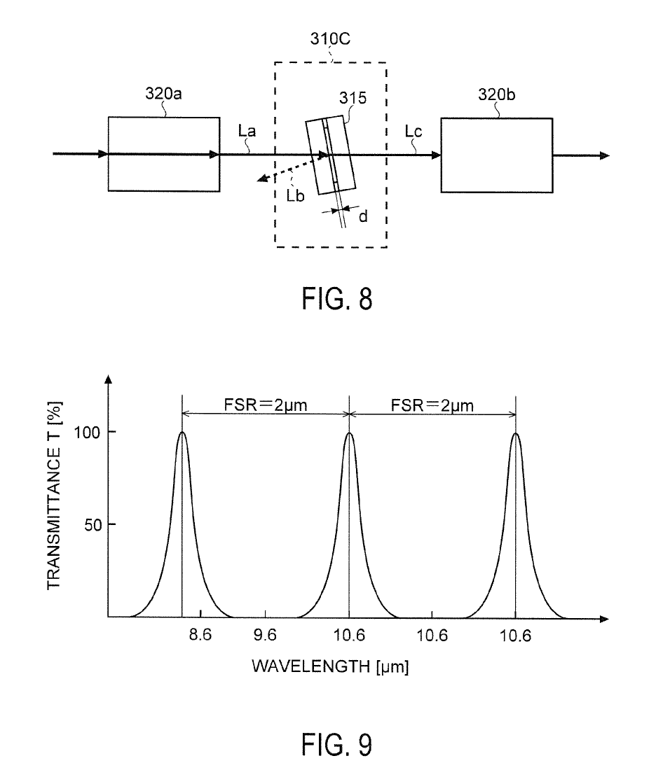

FIG. 8 schematically illustrates an exemplary configuration of a wavelength filter device according to a third example of the first embodiment. As shown in FIG. 8, a wavelength filter device 310C may include an etalon 315. The etalon 315 may include two substrates configured to transmit the pulse laser beam L1 therethrough. The two substrates may be assembled with a spacer provided therebetween such that the facing surfaces of the respective substrates are parallel to each other at a distance d. Each of the substrates may be coated with a partial reflection film having substantially the same reflectance to light contained in a bandwidth range of, for example, approximately 8 μm to approximately 11 μm, in which a CO₂ laser apparatus oscillates.

The etalon 315 may be positioned to be inclined relative to a beam path of the pulse laser beam La at a predetermined angle. The predetermined angle may be in an angle range in which a pulse laser beam Lb reflected by the etalon 315 does not enter the upstream amplifier 320a, light at a wavelength of 10.6 μm is transmitted through the etalon 315, and light at a wavelength of 9.6 μm is substantially not transmitted through the etalon 315.

Here, a free spectral range FSR of the etalon 315 may, for example, be obtained through Expression (1) below. Here, λ is a wavelength of a pulse laser beam, r is a refractive index of a space between the two substrates, and d is a distance between the two substrates.

FSR=λ2/(2rd) (1)

In Expression (1) above, when the refractive index r is 1 and the free spectral range FSR is 2 μm, the distance d is 28.1 μm.

3.4.3.2 Wavelength Dependence of Transmittance in Wavelength Dispersive Element

FIG. 9 shows a transmittance spectrum of the etalon shown in FIG. 8. As shown in FIG. 9, when the etalon 315 is positioned at such an angle that light at a wavelength of 10.6 μm is transmitted therethrough and light at a wavelength of 9.6 μm is reflected thereby and that the free spectral range FSR is 2 μm, the transmittance spectrum of the etalon 315 may be in such a shape that a plurality of transmission bandwidths appears at an interval of 2 μm. The plurality of transmission bandwidths may include a bandwidth containing a wavelength of 10.6 μm. Accordingly, with regard to the pulse laser beam La incident on the etalon 315 ASE light at a wavelength of 9.6 μm may not be transmitted through the etalon 315. Meanwhile, with regard to the pulse laser beam La incident on the etalon 315, light at a wavelength of 10.6 μm may be transmitted through the etalon 315 as the pulse laser beam Lc, and may enter the downstream amplifier 320b.

3.4.3.3 Effect

As described above, by configuring the wavelength filter device 310C using a wavelength dispersive element such as the etalon 315 in which transmittance varies depending on the wavelengths, unwanted ASE light at, for example, a wavelength of 9.6 μm may be blocked effectively.

3.4.4 Wavelength Filter Device Including Grating and Slit

3.4.4.1 Configuration of Wavelength Filter Device

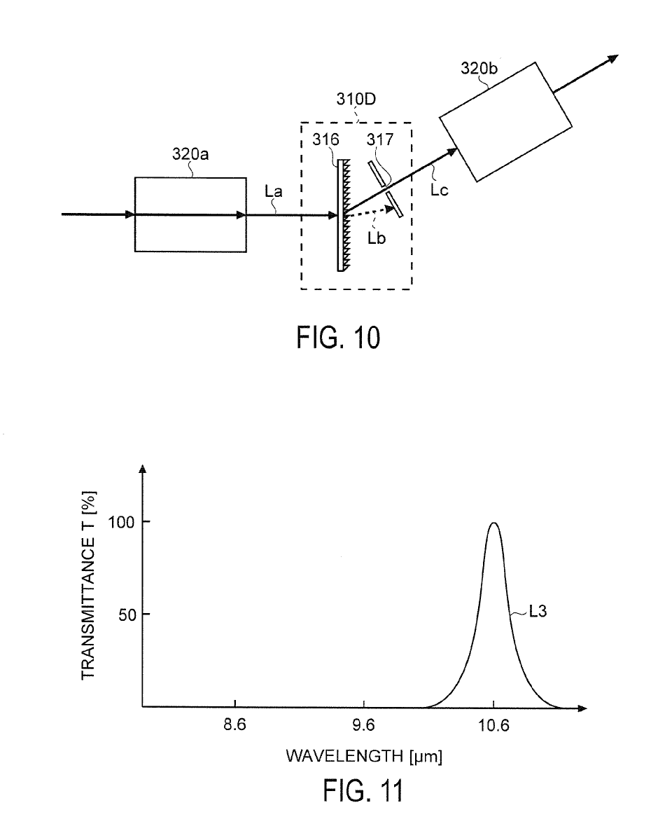

FIG. 10 schematically illustrates an exemplary configuration of a wavelength filter device according to a fourth example of the first embodiment. As shown in FIG. 10, a wavelength filter device 310D may include a grating 316 and a member having a slit 317. In the example shown in FIG. 10, the transmissive grating 316 may be used. In other embodiments, a reflective grating may be used instead.

The grating 316 may be provided in a beam path of the pulse laser beam La. The slit 317 may be positioned in a direction in which a first order diffracted ray of the pulse laser beam La at a wavelength of 10.6 μm diffracted by the grating 316 travels as the pulse laser beam Lc. Other diffracted rays, such as the first order diffracted ray of the pulse laser beam La at a wavelength of 9.6 μm, may be absorbed by the member having the slit 317 or by a beam dump (not separately shown).

3.4.4.2 Wavelength Selectivity of Wavelength Filter Device Including Grating and Slit

FIG. 11 shows wavelength selectivity of the wavelength filter device shown in FIG. 10. The diffraction angle of light by the grating 316 may depend on an angle of incidence of the pulse laser beam La on the diffraction surface of the grating 316, a wavelength of the incident pulse laser beam La, and a pitch of grooves formed in the grating 316. Accordingly, when the stated angle of incidence is constant, a direction into which diffracted rays of respective orders of the pulse laser beam La at the wavelength of 10.6 μm travel may be constant in accordance with the respective orders. The grating 316 and the slit 317 are positioned in such a relationship that allows the first order diffracted ray of the pulse laser beam La to be selectively transmitted through the slit 317. This relationship may result in a wavelength filter device 310d configured to allow the first order diffracted ray of the pulse laser beam La at a wavelength of 10.6 μm to be outputted as the pulse laser beam Lc.

3.4.4.3 Effect

As described above, configuring the wavelength filter device 310D by combining the grating 316 and the slit 317 may make it possible to substantially block unwanted light, such as the ASE light at a wavelength of 9.6 μm, effectively.

3.5 Wavelength Filter Device Including Polarization Filter

The ASE light outputted from the amplifier 320 may not be limited to ASE light at a wavelength of 9.6 μm but may include ASE light at a wavelength of 10.6 μm. Such ASE light at a wavelength of 10.6 μm may be reduced effectively by combining the above-described wavelength filter device with another filter. In the description to follow, a polarization filter will be illustrated as an example of such a filter, but the present disclosure is not limited thereto.

3.5.1 Wavelength Filter Device Including Single Polarization Filter

3.5.1.1 Configuration

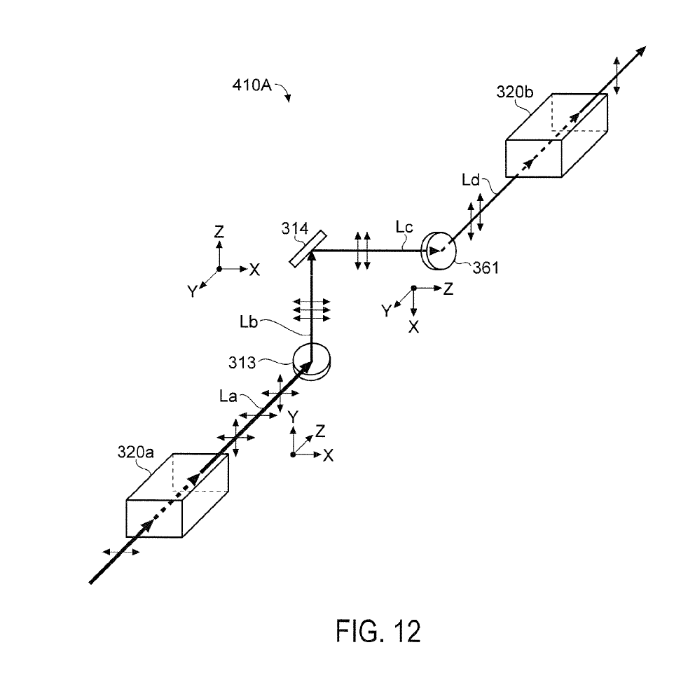

FIG. 12 schematically illustrates an exemplary configuration of a wavelength filter device which further includes a single polarization filter. As shown in FIG. 12, a wavelength filter device 410A may include the polarization mirrors 313 and 314 and a polarization filter 361. The polarization mirrors 313 and 314 may be similar to the polarization mirrors 313 and 314 shown in FIG. 7. Although a cooling mechanism is not provided in each of the polarization mirrors 313 and 314 in FIG. 12, the cooling mechanism may be provided as in the example shown in FIG. 7.

The polarization filter 361 may, for example, be a polarizer. The polarizer may be of a reflective type or a transmissive type. In the example shown in FIG. 12, the polarization filter 361 may include a reflective type polarizer. Further, the polarization filter 361 may be provided with a cooling mechanism (not separately shown). The cooling mechanism may be similar to the cooling mechanism shown in FIG. 7.

3.5.1.2 Wavelength Dependence of Reflectance on Polarization in Optical Elements

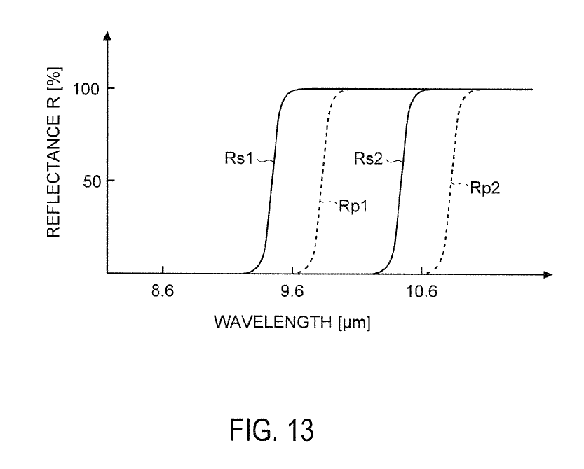

FIG. 13 shows wavelength dependence of reflectance on polarization in the optical elements shown in FIG. 12. In FIG. 13, a solid line Rs1 shows reflectance of the S-polarization component by the polarization mirrors 313 and 314, a broken line Rp1 shows reflectance of the P-polarization component by the polarization mirrors 313 and 314, a solid line Rs2 shows reflectance of the S-polarization component by the polarization filter 361, and a broken line Rp2 shows reflectance of the P-polarization component by the polarization filter 361. As shown in FIG. 13, the wavelength dependence of reflectance of the polarization mirrors 313 and 314 may be similar to the wavelength dependence of reflectance shown in FIG. 6. Meanwhile, the polarization filter 361 may substantially absorb the S-polarization component of light at wavelengths equal to or shorter than 10.3 μm and substantially reflect the S-polarization component of light at wavelengths longer than 10.3 μm. Further, the polarization filter 361 may substantially absorb the P-polarization component of light at wavelengths equal to or shorter than 10.6 μm and substantially reflect the P-polarization component of light at wavelengths longer than 10.6 μm. Thus, the filter device 410A may be configured by combining the polarization mirrors 313 and 314 which substantially reflect both the P-polarization component and the S-polarization component of light at a wavelength of 10.6 μm with the polarization filter 361 which substantially reflects only the S-polarization component of light at a wavelength of 10.6 μm.

3.5.1.3 Operation

As described with reference to FIGS. 12 and 13, the polarization mirrors 313 and 314 may reflect light at a wavelength of 10.6 μm. Thus, the pulse laser beam Lc reflected by the polarization mirror 314 may include ASE light at a wavelength of 10.6 μm. This ASE light at a wavelength of 10.6 μm may be unpolarized. Meanwhile, with regard to the incident pulse laser beam Lc, the polarization filter 361 may reflect the S-polarization component at a wavelength of 10.6 μm with high reflectance and transmit or absorb the P-polarization component at a wavelength of 10.6 μm with high transmittance or absorbance. Accordingly, the P-polarization component of the ASE light at a wavelength of 10.6 μm may be blocked by the polarization filter 361. Here, the polarization filter 361 may be positioned such that the pulse laser beam L1 outputted from the master oscillator 301 (see FIG. 1) is incident on the polarization filter 361 as mostly the S-polarization component.

3.5.1.4 Effect

The ratio of the S-polarization component to the P-polarization component in the unpolarized ASE light at a wavelength of 10.6 μm included in the pulse laser beam Lc may be approximately 1:1. Thus, the polarization filter 361 may reduce the ASE light at a wavelength of 10.6 μm to substantially a half. As a result, not only self-oscillation by ASE light at a wavelength of 9.6 μm but also self-oscillation by the ASE light at a wavelength of 10.6 μm may be reduced.

3.5.2 Wavelength Filter Device Including Multiple Polarization Filters

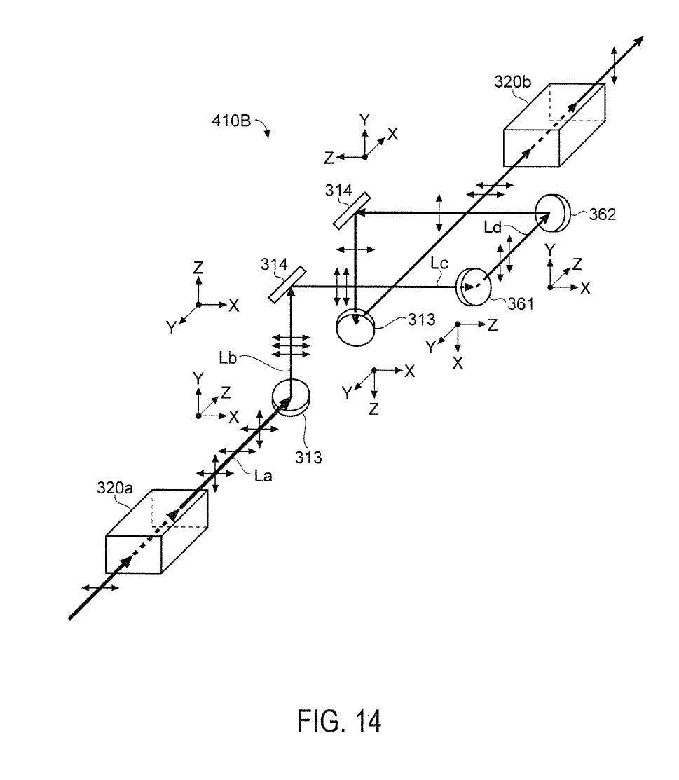

FIG. 14 schematically illustrates an exemplary configuration of a wavelength filter device which further includes two polarization filters. As shown in FIG. 14, a filter device 410B may include the polarization mirrors 313 and 314 and polarization filters 361 and 362. Each of the polarization mirrors 313 and 314 may be similar to the polarization mirrors 313 and 314 shown in FIG. 7. Each of the polarization filters 361 and 362 may be similar to the polarization filter 361 shown in FIG. 12. Although a cooling mechanism is not provided in each of the polarization mirrors 313 and 314 shown in FIG. 12, the cooling mechanism may be provided as in the example shown in FIG. 7. Further, each of the polarization filters 361 and 362 may be provided with a cooling mechanism (not separately shown). The cooling mechanism may be similar to the cooling mechanism shown in FIG. 7.

Wavelength dependence of reflectance on polarization in the polarization mirrors 313 and 314 may be similar to that shown in the solid line Rs1 and the broken line Rp1 in FIG. 13. Wavelength dependence of reflectance on polarization in the polarization filters 361 and 362 may be similar to that shown in the solid line Rs2 and the broken line Rp2 in FIG. 13.

As described above, by combining the plurality of polarization mirrors and the plurality of polarization filters, self-oscillation by ASE light and self-oscillation by ASE light at a wavelength of 10.6 μm may further be reduced.

### 4. EUV Light Generation Apparatus Used with Laser Apparatus

4.1 Exemplary Laser Produced Plasma Type EUV Light Generation System

4.1.1 Configuration

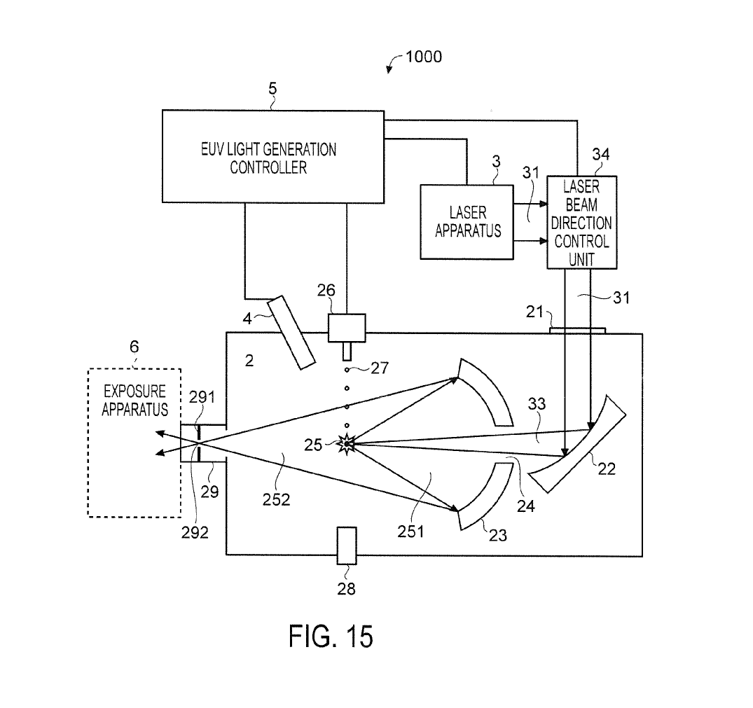

FIG. 15 schematically illustrates a configuration of an exemplary LPP type EUV light generation system. An EUV light generation apparatus 1000 may be used with at least one laser apparatus 3. Hereinafter, a system that includes the EUV light generation apparatus 1000 and the laser apparatus 3 may be referred to as an EUV light generation system. As illustrated in FIG. 15 and described in detail below, the EUV light generation system may include a chamber 2 and a target supply unit 26. The chamber 2 may be sealed airtight. The target supply unit 26 may be mounted on the chamber 2 to penetrate a wall of the chamber 2. A target material to be supplied by the target supply unit 26 may include, but is not limited to, tin, terbium, gadolinium, lithium, xenon, or any combination thereof.

The chamber 2 may have at least one through-hole formed in its wall, and a pulse laser beam 31 may travel through the through-hole into the chamber 2. Alternatively, the chamber 2 may have a window 21, through which the pulse laser beam 31 may travel into the chamber 2. An EUV collector mirror 23 having a spheroidal surface may, for example, be provided inside the chamber 2. The EUV collector mirror 23 may have a multi-layered reflective film formed on the spheroidal surface thereof. The reflective film may include a molybdenum layer and a silicon layer being laminated alternately. The EUV collector mirror 23 may have a first focus and a second focus, and may be positioned such that the first focus lies in a plasma generation region 25 and the second focus lies in an intermediate focus (IF) region 292 defined by the specification of an external apparatus, such as an exposure apparatus 6. The EUV collector mirror 23 may have a through-hole 24 formed at the center thereof, and a pulse laser beam 33 may travel through the through-hole 24 toward the plasma generation region 25.

The EUV light generation system may further include an EUV light generation controller 5 and a target sensor 4. The target sensor 4 may have an imaging function and detect at least one of the presence, the trajectory, and the position of a target 27. The EUV light generation controller 5 may be electrically connected to the laser apparatus 3 and the target supply unit 26.

Further, the EUV light generation system may include a connection part 29 that allows the interior of the chamber 2 and the interior of the exposure apparatus 6 to be in communication with each other. A wall 291 having an aperture may be provided inside the connection part 29, and the wall 291 may be positioned such that the second focus of the EUV collector mirror 23 lies in the aperture formed in the wall 291.

The EUV light generation system may further include a laser beam direction control unit 34, a laser beam focusing mirror 22, and a target collection device 28 for collecting targets 27. The laser beam direction control unit 34 may include an optical element (not separately shown) for defining the direction into which the pulse laser beam 31 travels and an actuator (not separately shown) for adjusting the position and the orientation (posture) of the optical element.

4.2.1 Operation

With continued reference to FIG. 15, a pulse laser beam 31 outputted from the laser apparatus 3 may pass through the laser beam direction control unit 34 and be outputted therefrom after having its direction optionally adjusted. The pulse laser beam 31 may travel through the window 1 and enter the chamber 2. The pulse laser beam 31 may travel inside the chamber 2 along at least one beam path, be reflected by the laser beam focusing mirror 22, and strike at least one target 27 as a pulse laser beam 33.

The target supply unit 26 may be configured to output the target(s) 27 toward the plasma generation region 25 inside the chamber 2. The target 27 may be irradiated with at least one pulse of the pulse laser beam 33. Upon being irradiated with the pulse laser beam 33, the target 27 may be turned into plasma, and rays of light including EUV light 251 may be emitted from the plasma. The EUV light 251 may be reflected selectively by the EUV collector mirror 23. EUV light 252, which is the light reflected by the EUV collector mirror 23, may travel through the intermediate focus region 292 and be outputted to the exposure apparatus 6. The target 27 may be irradiated with multiple pulses included in the pulse laser beam 33.

The EUV light generation controller 5 may integrally control the EUV light generation system. The EUV light generation controller 5 may process image data of the target 27 captured by the target sensor 4. Further, the EUV light generation controller 5 may control at least one of the timing at which the target 27 is outputted, the direction into which the target 27 travels, and the speed at which the target 27 travels. Furthermore, the EUV light generation controller 5 may control at least one of the timing at which the laser apparatus 3 oscillates, the direction in which the pulse laser beam 31 travels, and the position at which the pulse laser beam 33 is focused. It will be appreciated that the various controls mentioned above are merely examples, and other controls may be added as necessary.

4.2 EUV Light Generation Apparatus Used with Laser Apparatus Including Wavelength Filter Device: Second Embodiment

Hereinafter, a case where the above-described laser apparatus 300 is used with the EUV light generation apparatus 1000 shown in FIG. 15 will be described with reference to the drawings.

4.2.1 Configuration

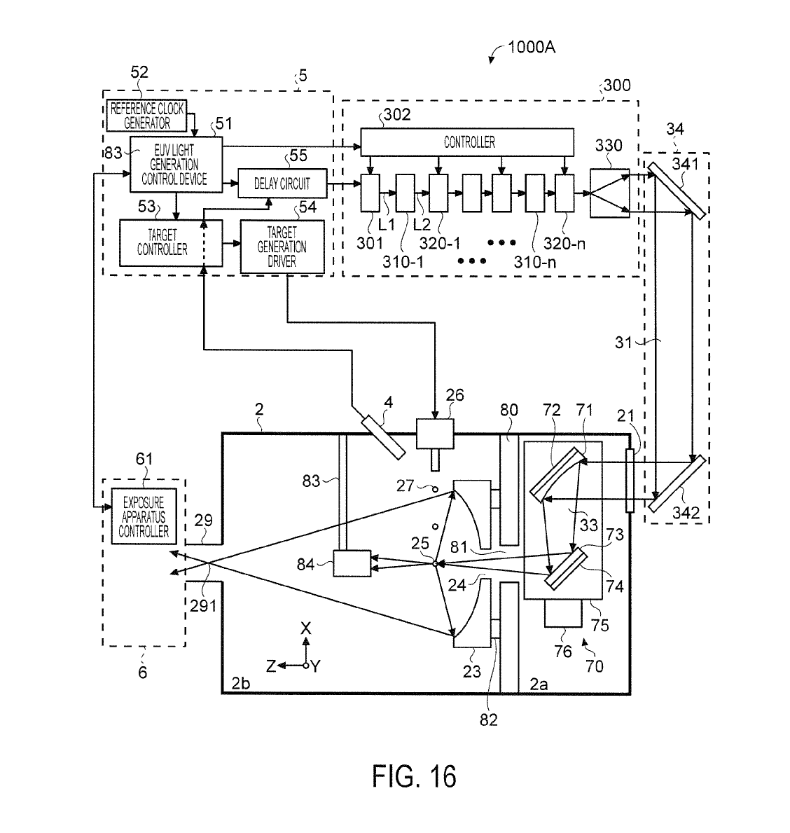

FIG. 16 schematically illustrates an exemplary configuration of an EUV light generation apparatus according to a second embodiment of the present disclosure. An EUV light generation apparatus 1000A shown in FIG. 16 may be similar in configuration to the EUV light generation apparatus 1000 shown in FIG. 15. The laser apparatus 3 shown in FIG. 15 may be replaced with the laser apparatus 300. Further, the EUV light generation controller 5 may include an EUV light generation control device 51, a reference clock generator 52, a target controller 53, a target generation driver 54, and a delay circuit 55.

The laser apparatus 300 may have a similar configuration to the laser apparatus 300 shown in FIG. 1. Accordingly, an output of a laser beam by self-oscillation in the laser apparatus 300 may be reduced. The pulse laser beam 31 outputted from the laser apparatus 300 may be guided into the chamber 2 by the laser beam direction control unit 34. The laser beam direction control unit 34 may include high-reflection mirrors 341 and 342 which reflect the pulse laser beam 31 with high reflectance.

The interior of the chamber 2 may be divided into two spaces 2a and 2b by a partition 80. The partition 80 may have a through-hole 81 formed therein, and the pulse laser beam 33 may travel through the through-hole 81 toward the plasma generation region 25. The EUV collector mirror 23 may be fixed to the partition 80 through a mirror holder 82. The EUV collector mirror 23 may be fixed to the partition 80 so that the pulse laser beam 31 that has passed through the through-hole 81 in the partition 80 passes through the through-hole 24 in the EUV collector mirror 23.

A laser beam focusing optical system 70 may be provided in the upstream space 2a. The laser beam focusing optical system 70 may include an off-axis paraboloidal mirror 71 and a high-reflection mirror 73. The off-axis paraboloidal mirror 71 and the high-reflection mirror 73 may be fixed to a moving stage 75 through respective mirror holders 72 and 74. The mirror holder 74 may be provided with an automatic tilt mechanism (not separately shown). The moving stage 75 may be provided with a moving mechanism 76. The moving mechanism 76 may be capable of moving the moving stage 75 in the X, Y, and Z-directions. A beam dump 84 may be provided in the chamber 2 to absorb the pulse laser beam 33 that has passed through the plasma generation region 25. The beam dump 84 may be fixed to the inner wall of the chamber 2 through a support member 83. The beam dump 84 and the support member 83 may be provided in an obscuration region of the EUV light 252.

4.2.2 Effect

By employing the laser apparatus 300 in which an output of a laser beam by self-oscillation is reduced in an EUV light generation system, a malfunction of the EUV light generation system by unwanted laser beams may be reduced, and the EUV light generation system may be stabilized thermally. As a result, the EUV light 252 may be stably generated.

### 5. Examples of Amplifier

5.1 Fast-Axial-Flow Amplifier

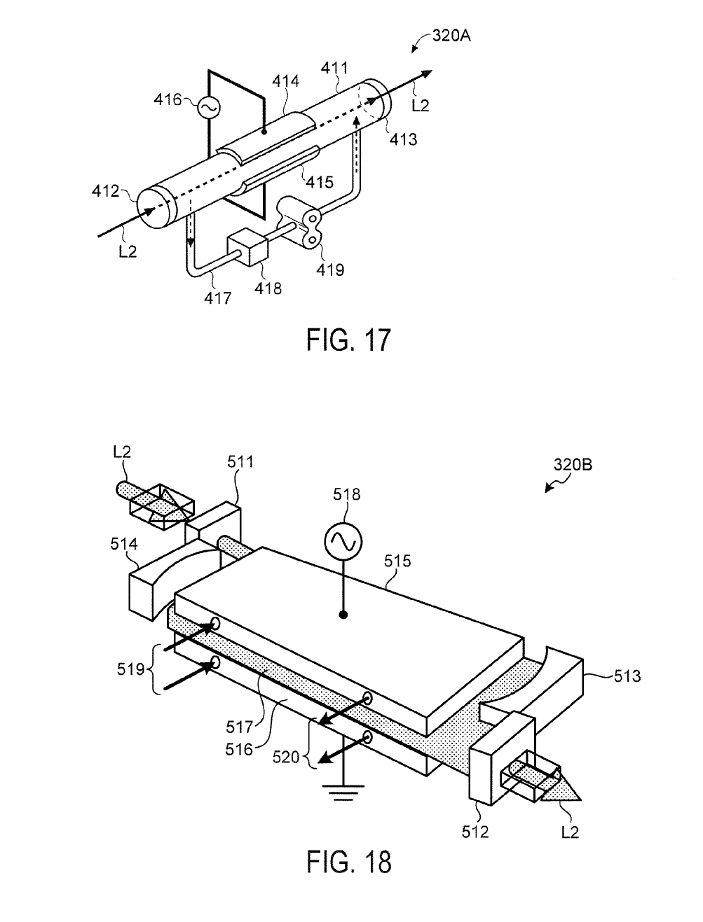

FIG. 17 schematically illustrates an exemplary configuration of a fast-axial-flow amplifier. As shown in FIG. 17, a fast-axial-flow amplifier 320A may include a discharge pipe 411, an input window 412, an output window 413, electrodes 414 and 415, an RF power supply 416, a gas pipe 417, a heat exchanger 418, and a blower 419. The pulse laser beam L2 may enter the fast-axial-flow amplifier 320A through the input window 412, travel through the discharge pipe 411, and be outputted through the output window 413. A gaseous gain medium may circulate in the discharge pipe 411 through the gas pipe 417 by the blower 419. An RF voltage may be applied by the RF power supply 416 between the electrodes 414 and 415 arranged with the discharge pipe 411 provided therebetween, and then the gain medium inside the discharge pipe 411 may be excited. Accordingly, the pulse laser beam L2 traveling through the discharge pipe 411 may be amplified. Heat accumulated in the gain medium by electric discharge may be removed by the heat exchanger 418 provided on the gas pipe 417.

5.2 Slab Amplifier

FIG. 18 schematically illustrates an exemplary configuration of a slab amplifier. In FIG. 18, an outer housing, such as a sealed container, of a slab amplifier 320B is omitted in order to show the internal configuration thereof. As shown in FIG. 18, the slab amplifier 320B may include an input window 511, discharge electrodes 515 and 516 provided to face each other, concave spherical mirrors 513 and 514, and an output window 512. The discharge electrode 516 may, for example, be grounded. An RF voltage may be applied between the discharge electrodes 515 and 516 by an RF power supply 518. A space between the discharge electrodes 515 and 516 may be filled with a gaseous gain medium. When a voltage is applied between the discharge electrodes 515 and 516, a discharge region 517 may be formed in the space between the discharge electrodes 515 and 516. In the discharge region 517, the gain medium may be excited by the electric discharge. The pulse laser beam L2 may enter the slab amplifier 320B through the input window 511. Each of the concave spherical mirrors 513 and 514 may reflect the pulse laser beam L2 incident thereon. The reflected pulse laser beam L2 may travel back and forth in the discharge region 517. The pulse laser beam L2 may be supplied with energy as it travels through the discharge region 517, to thereby be amplified. Thereafter, the amplified pulse laser beam L2 may be outputted through the output window 512. A flow channel (not separately shown) through which a cooling medium 519 supplied from a cooling device (not separately shown) flows may be formed in each of the discharge electrodes 515 and 516. The cooling medium 519 supplied from the cooling device may remove heat accumulated in each of the discharge electrodes 515 and 516 by the electric discharge while the cooling medium 519 flows through the flow channel inside each of the discharge electrodes 515 and 516. Then, the cooling medium 519 may flow out of each of the discharge electrodes 515 and 516 as waste water 520.

5.3 Triaxial Orthogonal Amplifier

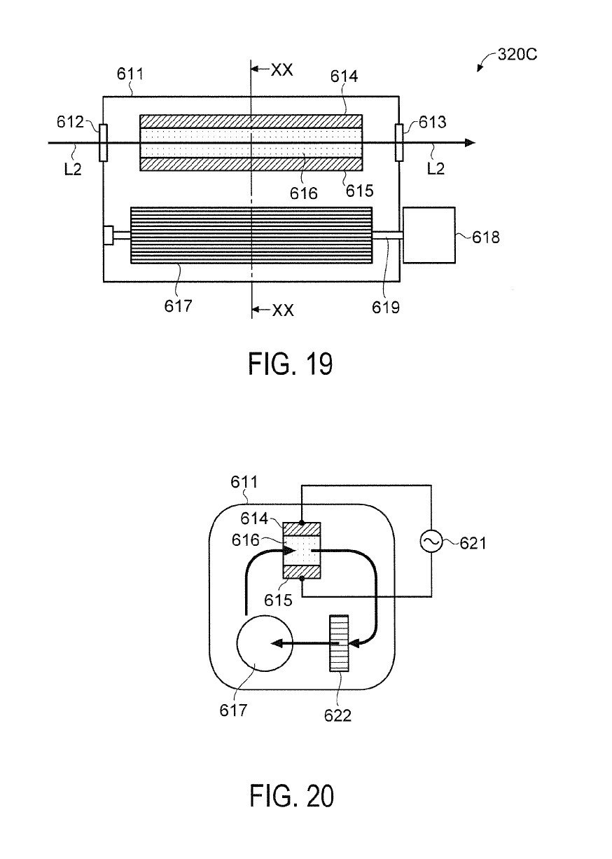

FIG. 19 schematically illustrates an exemplary configuration of a triaxial orthogonal amplifier. FIG. 20 is a sectional view of the triaxial orthogonal amplifier shown in FIG. 19, taken along XX-XX plane. As shown in FIGS. 19 and 20, a triaxial orthogonal amplifier 320C may include a chamber 611, an input window 612, an output window 613, electrodes 614 and 615 provided to face each other, a crossflow fan 617, and a heat exchanger 622. The chamber 611 may be filled with a gaseous gain medium. The electrodes 614 and 615 may be connected to an RF power supply 621. An RF voltage may be applied between the electrodes 614 and 615 by the RF power supply 621, and then the gain medium between the electrodes 614 and 615 may be excited. Thus, an amplification region 616 may be formed between the electrodes 614 and 615. The pulse laser beam L2 that has entered the triaxial orthogonal amplifier 320C through the input window 612 may be amplified as it travels through the amplification region 616 between the electrodes 614 and 615. Thereafter, the pulse laser beam L2 may be outputted through the output window 613. The crossflow fan 617 may be connected to a motor 618 through a rotational shaft 619 provided either inside or outside the chamber 611. Rotating the crossflow fan 617 by actuating the motor 618 may allow the gain medium to circulate inside the chamber 611. Heat accumulated in the gain medium by the electric discharge may be removed by the heat exchanger 622 as the gain medium passes through the heat exchanger 622.

### 6 Examples of Master Oscillator

6.1 CO₂ Laser

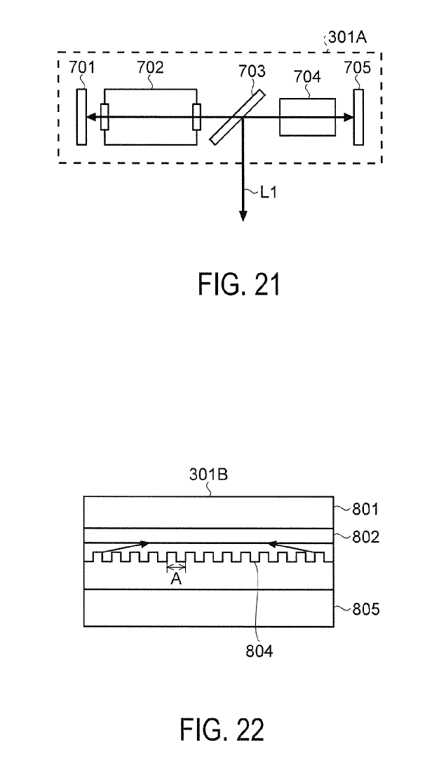

FIG. 21 schematically illustrates an exemplary configuration of a CO₂ laser, which may be used as a master oscillator. As shown in FIG. 21, a CO₂ laser 301A may include two resonator mirrors 701 and 705, a chamber 702, a polarization beam splitter 703, and a Pockels cell 704. The chamber 702, the polarization beam splitter 703, and the Pockels cell 704 may be provided in a beam path of a resonator formed by the resonator mirrors 701 and 705. The chamber 702 may be filled with a laser gas containing CO₂ gas as a primary gain medium.

The CO₂ laser 301A may be configured to output a pulse laser beam L1 at a wavelength contained in a gain bandwidth of the amplifier 320. Accordingly, when the CO₂ laser 301A is used as the master oscillator 301, the gain efficiency of the laser apparatus 300 may be improved.

6.2 Distributed Feedback Laser

FIG. 22 schematically illustrates an exemplary configuration of a quantum cascade laser, which may be used as a master oscillator. A quantum cascade laser 301B may be a distributed-feedback laser as shown in FIG. 22. As shown in FIG. 22, the quantum cascade laser 301B may be configured by forming a grating 804 near an active layer 802. For example, the grating 804 may be formed on or under the active layer 802. The quantum cascade laser 301B may further include a clad layer 801. With the quantum cascade laser 301B configured as such, a wavelength at which the reflectance reaches the maximum may be generally expressed in Expression (2) below.

λ=λb±δλ (2)

In Expression (2), λb=2 nA/m shows a wavelength for Bragg reflection, where A is a pitch of grating and m is an order of diffraction. A selected wavelength width 2δλ may be determined by a depth of grooves in the grating 804, a resonator length, and so forth. By designing the quantum cascade laser 301B such that the selected wavelength width 262 of the grating 804 selects a single longitudinal mode by the resonator length of the quantum cascade laser 301B, the quantum cascade laser 301B may oscillate in a single longitudinal mode. An oscillation wavelength of this single longitudinal mode may be controlled by controlling a temperature of the quantum cascade laser 301B through a Peltier device 805. Accordingly, an oscillation wavelength of the quantum cascade laser 301B may be stabilized within a single gain bandwidth of the amplifier 320. As a result, the pulse laser beam L2 may be amplified efficiently.

In this example, the grating 804 may be formed on or under the active layer 802 so that the selected wavelength width 2δλ of the grating 804 achieves a wavelength selection width where a plurality of gain bandwidths can be selected. Further, wavelength interval L_{FSR} of a longitudinal mode by the resonator length of the quantum cascade laser 301B may be set to 0.0206 μm. With such a configuration, the quantum cascade laser 301B may oscillate in a multi-longitudinal mode. For example, the quantum cascade laser 301B capable of oscillating simultaneously in seven gain bandwidths of the gain bandwidths of the amplifier 320 may be obtained. The control of the longitudinal modes in this case may be achieved by controlling the temperature of the quantum cascade laser 301B through the Peltier device 805 with high precision. According to this configuration, an etalon, a grating, or the like need not be provided in an external resonator, and a laser apparatus can be reduced in size and increased in power. Further, the spectrum of the laser beam can be stabilized with ease.

The above-described embodiments and the modifications thereof are merely examples for implementing the present disclosure, and the present disclosure is not limited thereto. Making various modifications according to the specifications or the like is within the scope of the present disclosure, and other various embodiments are possible within the scope of the present disclosure. For example, the modifications illustrated for particular embodiments can be applied to other embodiments as well (including the other embodiments described herein).

The terms used in this specification and the appended claims should be interpreted as “non-limiting.” For example, the terms “include” and “be included” should be interpreted as “including the stated elements but not limited to the stated elements.” The term “have” should be interpreted as “having the stated elements but not limited to the stated elements.” Further, the modifier “one (a/an)” should be interpreted as “at least one” or “one or more.”

What is claimed is:

1. A laser apparatus, comprising:
at least one oscillator configured to output a first laser beam;
a filter device provided in a beam path of the first laser beam, the filter device including either an optical element having transmittance properties depending on a polarization direction and a wavelength or a wavelength dispersive element; and
at least one amplifier configured to amplify a second laser beam from the filter device and output as a third laser beam.

2. The laser apparatus according to claim 1, wherein the filter device further includes:
a first polarization mirror on which the first laser beam is incident; and
a second polarization mirror on which at least one of a laser beam transmitted through the first polarization mirror and a laser beam reflected by the first polarization mirror is incident, the second polarization mirror being positioned such that a line normal to a surface of the first polarization mirror on which the laser beam is incident is substantially orthogonal to a line normal to a surface of the second polarization mirror on which the laser beam is incident.

3. The laser apparatus according to claim 2, further comprising at least one polarization filter provided in a beam path of the second laser beam.

4. The laser apparatus according to claim 1, wherein the wavelength dispersive element is one of an etalon or a grating.
